(19) United States
(12) Patent Application Publication
(10) Pub. No.: US 2015/0142597 A1
(43) Pub. Date: May 21, 2015

(54) REVERSE DUTCH AUCTION PROCESSING METHOD EXECUTED BY A COMPUTER SERVER AND COMPUTER PROGRAMS THEREOF

(71) Applicant: SMART SEEKER S.L., GIRONA (ES)

(72) Inventors: JAUME DEYA RIPOLL, GIRONA (ES); JOSEPH LLUIS DE LA ROSA ESTEVA, ILLES BALEARS (ES)

(21) Appl. No.: 14/084,722

(22) Filed: Nov. 20, 2013

(51) Int. Cl. G06Q 30/08

(52) U.S. Cl. CPC G06Q 30/08
USPC 705/26.3

(57) ABSTRACT

A reverse dutch auction processing method executed by a computer server and computer programs thereof; A user sends a request including at least a value for a parameter representative of a property of the product or service and a maximum first acceptance time period for a product or a service to potential providers; the potential providers receiving the request, wherein in case of acceptance of the request by at least one of the potential providers within said maximum first acceptance time period, closing the request upon confirmation by the user, and in case of no acceptance of the request by any of the providers indicating, by at least one of the providers, an alternative minimum value for the parameter of the requested product or service within or after the maximum first acceptance time period, the user confirming the alternative minimum value by calculating at least a temporary probability of acceptance.

### FIELD OF THE INVENTION

This invention generally relates to auctions methods, and more particularly to a reverse dutch auction processing method executed by a computer server and computer programs thereof.

### BACKGROUND OF THE INVENTION

Electronic and online auctions provide a convenient mechanism for buying and selling goods and/or services. In a simple dutch auction, a seller or provider tells a price and after a period of time he moves on with a different lower price. The process is repeated until a buyer or user, accepts the deal.

In a Reverse Dutch Auction the buyer is the one who tells a price and after a period of time he moves on with a different upper price. The process is repeated until a seller accepts the deal.

A case of the Reverse Dutch Auction is when the buyer tells a price and he waits for a seller to accept the goods and/or services at that price within a period of time. There are no reprising steps, being the winner only possible at an only step of accepting the deal. This is the one-shot Reverse Dutch Auction.

The main problem of the reverse Dutch auction is that the buyer does not dare to accept the proposal because perhaps considers that the price can still be improved.

Consequently, an object of the invention is to allow said buyer deciding the probability of acceptance of the proposal being the process also open to other sellers in case a one shot reverse dutch auction not being completed.

### SUMMARY OF THE INVENTION

This invention proposal provides an improvement in the one-shot reverse dutch auction allowing that other sellers appearing in the action in case a first deal is not accepted.

Therefore one aspect of the invention provides a reverse dutch auction processing method executed by a computer, comprising:
a user sending a request for a product or a service to a plurality of potential providers through a computer and a communication network, said request including at least a value for a parameter representative of a property of said product or service and a maximum first acceptance time period; and said product or service being stored in a database;
receiving, said plurality of potential providers, said request from said computer; and
in case of acceptance of the request by at least one of said plurality of potential providers within said maximum first acceptance time period, closing the request upon confirmation of the user,
   wherein in case of no acceptance of the request by said plurality of potential providers at least one of the potential providers indicates, an alternative minimum value for said parameter of said requested product or service within or after said maximum first acceptance time period, the user confirming said alternative minimum value, wherein said confirmation comprises calculating at least a temporary probability of said acceptance considering: total number of said products or services stored in said database complying with minimum requirements set by the user, a value for said parameter for said request, an alternative minimum value indicated by the potential provider, and a constant comprising a value between 0 and 1 that regulates how important is the difference between values of said parameter.

In an embodiment, the confirmation further comprises computing reliability of an historic of the requests and an historical probability of said acceptance considering: reliability of the experience that the user has in similar requests, number of similar proposals included in an historic, time in which said historic is considered, penalty that a request has considering the time in which was occurred, period of time that has passed between a request k of the historic and the request, a calculated temporary probability, a temporary probability of the request k of the historic; a number of similar requests of said accepted request and a number of the total similar calculated requests.

In an embodiment, the first acceptance time period lasts until at least a second provider accepts the user request. In this case, the provider that firstly accepts the request may have priority rights over the rest of providers that have also accepted the request. Alternatively, on other hand, it could be the user the one that decides to which provider confirm the request.

Although the proposed method had been described with a single attribute, the price. With the proposed method, any product or service can be auctioned, i.e. price, quality, among any other multi-attribute.

The subject matter described herein can be implemented in software in combination with hardware and/or firmware, or a suitable combination of them. For example, the subject matter described herein can be implemented in software executed by a processor.

Another aspect of the invention provides a computer program product having program instructions for instructing a processor of a computer system to calculate, when said program instructions are executed on a computer, a digital signal processor, a field-programmable gate array, an application-specific integrated circuit, a micro-processor, a micro-controller, or any other form of programmable hardware, at least a temporary probability of acceptance of an alternative minimum value, received from at least one of a plurality of potential providers, for a parameter representative of a property of a product or service, said request being received from a user for said product or service and not being accepted by any of said plurality of potential providers within a maximum first acceptance time period, considering: total number of said products or services stored in a database complying with the minimum requirements set by said user, a value for said parameter for said request, an alternative minimum value indicated by said at least one provider, and a constant comprising a value between 0 and 1 that regulates how important is the difference between values of said parameter

### BRIEF DESCRIPTION OF THE DRAWINGS

The previous and other advantages and features will be more fully understood from the following detailed description, with reference to the attached, which must be considered in an illustrative and non-limiting manner, in which:

FIG. 1 is an illustration of an infrastructure where the proposed reverse dutch auction processing method can be implemented.

### DETAILED DESCRIPTION OF THE INVENTION

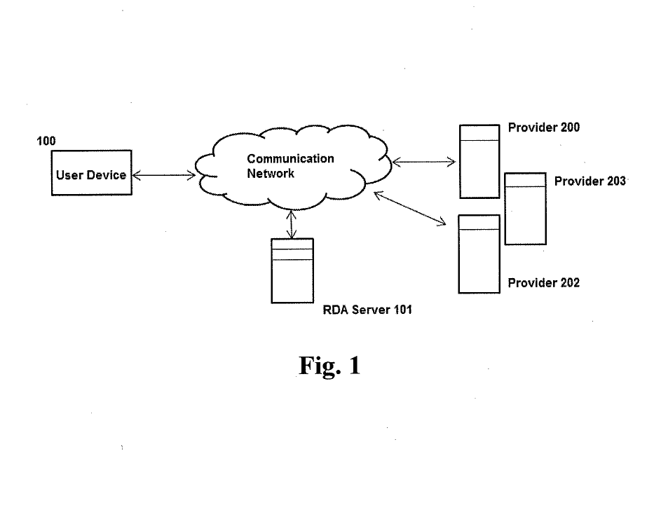

FIG. 1 illustrates a general infrastructure in which the proposed reverse dutch auction processing method could be implemented. A user, may access the reverse dutch auction server 101 which is configured to provide the reverse dutch auction service through any computing device 100 such as a PC, a laptop, an smartphone, a table, a PDA, among any other, to request a product or service, which is stored in a database not shown in the figure, to one or several potential providers.

The communication network may include circuit-switched and/or packet-switched technologies and devices, such as routers, switches, hubs, gateways (e.g., residential gateways, including a DSL or cable modem), or IP multimedia subsystem (IMS)-based networks for facilitating communications between the user device 100 and the reverse dutch auction server 101. Furthermore, said communication network may include wired and/or wireless components utilizing, e.g., IEEE 802.11 standards for providing over-the-air transmissions of communications. The communication network could be an IP-based network to facilitate communication between the reverse dutch auction server 101 and the user.

The communication network may be implemented using wireless protocols and technologies, such as WiFi, WiMax, Bluetooth, etc. The communication network can also be a packet-switched network as a local area network, wide area network, metropolitan area network, Internet network, or other similar type of network environment. The communication network may be a cellular communications network, a fixed wireless network, a wireless local area network (LAN), a wireless wide area network (WAN), a personal area network (PAN), a virtual private network (VPN), an intranet or other suitable network system, and the communication network comprises equipment for receiving and transmitting signals such as a base station tower and mobile switching center.

The request sent by said user would include a value for a parameter representative of a property of said product or service and a maximum acceptance period of time in which the user is willing to wait for said request being accepted. That is, a priority lapse is established. In case of acceptance, by one of said providers 200 for instance within said maximum acceptance time period the request is closed upon confirmation of the user.

In accordance with one aspect, in case none of said potential providers accepts the request, and upon a provider indicating an alternative minimum value for the parameter proposed by the user for that product or service, within or after said maximum acceptance time period, the user in order to confirm the alternative minimum value calculates a temporary probability of said acceptance taking into consideration: the total number of said products or services stored in the database which complies with the minimum requirements set by the user, a value for said parameter for said request, an alternative minimum value indicated by the potential provider, and a constant comprising a value between 0 and 1 that regulates how important is the difference between values of said parameter.

In an embodiment, the maximum acceptance period of time could be a time period between 1 hour and 24 hours (1 day). Alternatively, it could be also, for instance, more than 24 hours.

In an embodiment, the maximum acceptance period of time could last until any other provider/s 202, 203 . . . join the deal. In this case, different options are envisaged. For instance provider 200 that has firstly accepted the request may be granted as having priority over the rest of providers 202, 203 . . . that may have also accepted the request. Alternatively, this priority rights may be given by the user, that is, even provider 200 is the first one in making a counteroffer is the user who decides to which provider confirm the request.

In an embodiment, it is also possible that provider 200 upon indicating the alternative minimum value for the parameter proposed by the user for that product or service that is, upon making a counteroffer for said request, may also claim their want to grasp the deal at once.

The temporary probability to be determined by the user will mark which the probability for a proposal, request, to be accepted is. The temporary probability only takes into account current variables. One exemplary embodiment considers calculating the temporary probability by means of following function:

$${PM}_{i} = {\sum }_{k = 1}^{m} ( \frac{{p}_{i} - ( {p}_{k} * σ )}{{p}_{k}} ) ,$$

where: m is said total number of the products or services stored in the database complying with minimum requirements set by the user, pᵢ is said value for said parameter for the request, pₖ is said alternative minimum value indicated by the potential provider, and σ is said constant with comprising a value between 0 and 1.

Then, the temporary probability could be further normalized by means of following function:

$${PM}_{i} = \frac{2 ( 1 - \frac{δ}{{pm}_{i}} )}{2} ,$$

where δ is a constant that regulates how much optimistic is the temporary probability.

In an embodiment, to strengthen the confirmation process by the user it may also be computed reliability of an historic of the requests and an historical probability of the acceptance. The reliability of an historic of the requests will be calculated by considering the reliability of the experience that the user has in similar requests, the number of similar proposals included in an historic, the time in which said historic is considered, the penalty that a request has considering the time in which was occurred, the period of time that has passed between a request of the historic and the request for said product or service sent by the user, previous calculated temporary probability of the current request or proposal and temporary probability of the request of the historic. As a preferred option, following function will be used:

$${q}_{i} = {\sum }_{k = 1}^{n} ( \frac{β - {d}_{k}}{β} + γ * ( 1 - \frac{β - {d}_{k}}{β} ) ) * ( 1 - \vert {PM}_{i} - {PM}_{k} \vert ) ,$$

where: qᵢ is a variable that gathers the reliability of the experience that the user has in similar requests, n is the number of similar proposals included in an historic, β is a constant that marks the time in which the historic is considered, γ is a constant that graduates the penalty that a request has considering the time in which was occurred, dₖ is said period of time that has passed between the request of the historic and the request for said product or service, PMᵢ is the calculated temporary probability, and PMₖ is the temporary probability of the request of the historic.

As qᵢ is a cumulative variable, it could be normalized between 0 and 1. Therefore, reliability Fᵢ will be defined as

$${F}_{i} = \frac{2 ( 1 - \frac{α}{{q}_{i}} )}{2} ,$$

being α constant that regulates how much tough the reliability is.

On the other hand, the historical probability of the acceptance will mark which is the probability for a request to be accepted only from the historical, that is, how many requests have been accepted in the past with respect to similar requests. Preferably, the historical probability will be calculated by means of

$${PH}_{i} = \frac{PropA}{PropT} ,$$

where PropA is the number of similar requests of said accepted request, and PropT is the number of the total similar calculated requests.

Embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, a data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA (field programmable gate array) or an ASIC (application-specific integrated circuit).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

It will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims.

1. A reverse dutch auction processing method executed by a computer server, comprising:
a user sending a request for a product or a service to a plurality of potential providers through a user computer device and a communication network,
said request for said product or service including at least a value for a parameter representative of a property of said product or service and a maximum first acceptance time period; and
said product or service being stored in a database;
receiving, said plurality of potential providers, said request for said product or service from said computer; and
in case of acceptance of the request for said product or service by at least one of said plurality of potential providers within said maximum first acceptance time period, closing the request upon confirmation of the user,
wherein in case of no acceptance of the request for said product or service by said plurality of potential providers said reverse dutch auction processing method comprises indicating, by at least one of the potential providers, an alternative minimum value for said parameter of said requested product or service within or after said maximum first acceptance time period, the user confirming said alternative minimum value, wherein said confirmation comprises calculating at least a temporary probability of said acceptance considering: total number of said products or services stored in said database complying with minimum requirements set by the user, a value for said parameter for said request, an alternative minimum value indicated by the potential provider, and a constant comprising a value between 0 and 1 that regulates how important is the difference between values of said parameter.

2. A reverse dutch auction processing method according to claim 1, wherein said temporary probability of said acceptance is calculated by means of following function:
$${PM}_{i} = {\sum }_{k = 1}^{m} ( \frac{{p}_{i} - ( {p}_{k} * σ )}{{p}_{k}} )$$
where:
m is said total number of the products or services stored in the database complying with minimum requirements set by the user,
pᵢ is said value for said parameter for the request,
pₖ is said alternative minimum value indicated by the potential provider, and
σ is said constant with comprising a value between 0 and 1.

3. A reverse dutch auction processing method according to claim 1, wherein said confirmation further comprises computing reliability of an historic of the requests and an historical probability of said acceptance considering: reliability of the experience that the user has in similar requests, number of similar proposals included in an historic, time in which said historic is considered, penalty that a request has considering the time in which was occurred, period of time that has passed between a request included in the historic and the request for said product or service, a calculated temporary probability, a temporary probability of the request included in the historic; a number of similar requests of said accepted request for said product or service and a number of the total similar calculated requests.

4. A reverse dutch auction processing method according to claim 3, wherein said reliability of an historic of the requests and said historical probability of said acceptance are calculated by means of following functions:
$${q}_{i} = {\sum }_{k = 1}^{n} ( \frac{β - {d}_{k}}{β} + γ * ( 1 - \frac{β - {d}_{k}}{β} ) ) * ( 1 - \vert {PM}_{i} - {PM}_{k} \vert ) ; and$$
$${PH}_{i} = \frac{PropA}{PropT}$$
where:
qᵢ is a variable that gathers said reliability of the experience that the user has in similar requests,
n is said number of similar proposals included in an historic,
β is a constant that marks said time in which the historic is considered,
γ is a constant that graduates said penalty that a request has considering the time in which was occurred,
dₖ is said period of time that has passed between the request k of the historic and the request for said product or service,
PMᵢ is said calculated temporary probability, and
PMₖ is said temporary probability of the request included in the historic; and
where:
PropA is said number of requests similar to said accepted request for said product or service,
PropT is said number of the total similar calculated requests.

5. A reverse dutch auction processing method according to claim 1, wherein said first acceptance time period comprises a period between one hour and 24 hours.

6. A reverse dutch auction processing method according to claim 1, wherein said first acceptance time period is more than 24 hours.

7. A reverse dutch auction processing method according to claim 1, wherein said first acceptance time period lasts until at least a second provider accepts the user request for said product or service.

8. A reverse dutch auction processing method according to claim 7, wherein the provider that firstly accepts the request for said product or service has priority rights over the rest of providers that have also accepted the request.

9. A reverse dutch auction processing method according to claim 7, wherein the user decides to which provider confirm the request for said product or service.

10. A reverse dutch auction processing method according to claim 1 wherein said value for a parameter representative of a property of said product or service is selected among at least a price or quality of said product or service.

11. A computer program product having program instructions for instructing a processor of a computer system to calculate, when said program instructions are executed on a computer, a digital signal processor, a field-programmable gate array, an application-specific integrated circuit, a micro-processor, a micro-controller, or any other form of programmable hardware,
at least a temporary probability of acceptance of an alternative minimum value, received from at least one of a plurality of potential providers, for a parameter representative of a property of a product or service, said request being received from a user for said product or service and not being accepted by any of said plurality of potential providers within a maximum first acceptance time period, considering: total number of said products or services stored in a database complying with the minimum requirements set by said user, a value for said parameter for said request, an alternative minimum value indicated by said at least one provider, and a constant comprising a value between 0 and 1 that regulates how important is the difference between values of said parameter.

12. A computer program product according to claim 11, wherein said program code further causing said computer system to calculate a reliability of an historic of the requests and an historical probability of said acceptance by considering: reliability of the experience that the user has in similar requests, number of similar proposals included in an historic, time in which said historic is considered, penalty that a request has considering the time in which was occurred, period of time that has passed between a request included in the historic and the request for said product or service, a calculated temporary probability, a temporary probability of the request included in the historic; a number of similar requests of said accepted request for said product or service and a number of the total similar calculated requests.
